(19) United States
(12) Patent Application Publication
(10) Pub. No.: US 2022/0400051 A1
(43) Pub. Date: Dec. 15, 2022

(54) METHOD AND APPARATUS FOR DEVICE PROVISIONING

(71) Applicant: ELECTRONICS AND TELECOMMUNICATIONS RESEARCH INSITUTE, Daejeon (KR)

(72) Inventors: Mi-Ryong PARK, Daejeon (KR); Jung Sik SUNG, Daejeon (KR); Dae Ho KIM, Daejeon (KR); Hoyong KANG, Daejeon (KR); Seung Sik LEE, Daejeon (KR)

(73) Assignee: ELECTRONICS AND TELECOMMUNICATIONS RESEARCH INSTITUTE, Daejeon (KR)

(21) Appl. No.: 17/830,785

(22) Filed: Jun. 2, 2022

(30) Foreign Application Priority Data
Jun. 11, 2021 (KR) 10-2021-0075888
Apr. 5, 2022 (KR) 10-2022-0042386

(51) Int. Cl. H04L 41/0816; H04L 41/0806; G16Y 40/35

(52) U.S. Cl. CPC H04L 41/0816; H04L 41/0806; G16Y 40/35

(57) ABSTRACT

A method for device provisioning so that a new device can connect a first repeater in a smart terminal is provided. The method for device provisioning includes changing network setting information of a second repeater constituting a network for installation based on initial setting information of the new device, and when the new device connects to the second repeater using the initial setting information of the new device, changing the network setting information of the new device to the network setting information of the first repeater.

### CROSS-REFERENCE TO RELATED APPLICATION

This application claims priority to and the benefit of Korean Patent Application Nos. 10-2021-0075888 and 10-2022-0042386 filed in the Korean Intellectual Property Office on Jun. 11, 2021, and Apr. 5, 2022, the entire contents of which are incorporated herein by reference.

### BACKGROUND OF THE INVENTION

### (a) Field of the Invention

The present invention relates to a method and apparatus for device provisioning, and more particularly, to a method and apparatus for device provisioning to provision an IoT (Internet of things) device so that the IoT device can connect to an existing IoT network.

### (b) Description of the Related Art

Currently, IoT (Internet of things) devices are receiving services by connecting an IoT repeater [e.g., WiFi AP (Access Point), PAN (Personal Area Network) coordinator, Bluetooth pairing, gateway, etc.] according to a communication method [e.g., WiFi, Zigbee, BLE (Bluetooth Low Energy), IEEE 802.15.4, LPWA (Low Power Wide Area), etc.] supported by each device.

These IoT devices or IoT repeaters provide various types of connection methods for each selling company or communication method. In some cases, the smart terminal connects to the IoT device and changes the network setting of the IoT device so that the IoT device can connect to the IoT repeater. However, in the absence of the IoT repeater, there are many IoT devices in which it is difficult to set up a network through a smart terminal.

When a new IoT device is added to the currently operating general IoT network currently in operation or secure IoT network, connection initialization information must be provided in various forms depending on the communication method to the new IoT device. However, each company does not disclose connection initialization information, and most of the connection initialization information for each company is configured in a form that is difficult for third-party IoT devices to connect.

In addition, if a new IoT device can connect through one-to-one communication such as Bluetooth or WiFi, network setting is possible, but it is generally difficult to add various communication devices to an IoT device.

As such, the communication method or initial connection method is different depending on the manufacturer of the IoT device, so it is difficult to connect the IoT device and the IoT repeater. Even when the device is connected through standardized communication methods such as WiFi, Zigbee, BLE, IEEE 802.15.4, LPWA, etc., the network connection information of the currently operating IoT repeater is not set in the new IoT device, so a situation in which it is difficult for the device to initially access the operating IoT network or secure IoT network occurs.

### SUMMARY OF THE INVENTION

The disclosure has been made in an effort to provide a method and apparatus for device provisioning capable of adding a new IoT device to an operating IoT network without affecting the operating IoT network.

According to an exemplary embodiment, a method for provisioning so that a new device can connect a first repeater in the smart terminal is provided. The method for device provisioning includes: changing the network setting information of a second repeater constituting a network for installation based on the initial setting information of the new device; and when the new device connects to the second repeater using the initial setting information of the new device, changing the network setting information of the new device to the network setting information of the first repeater.

The changing of the network setting information of the new device may include connecting to the second repeater; and searching the new device from among devices connected to the second repeater by using the initial setting information of the new device.

The method for device provisioning may further include obtaining the initial setting information of the new device, wherein the initial setting information may include network setting information for network connection of the new device.

The obtaining may include obtaining the initial setting information through at least one of a QR (Quick Response) code of the new device, barcode recognition, or information provided by the cloud.

The changing of the network setting information of the second repeater may include changing the network setting information of the second repeater to the network setting information of the new device.

The method for device provisioning may further include connecting, by the new device, to the first repeater using the changed network setting information.

According to another embodiment, an apparatus for device provisioning so that a new device can connect a first repeater is provided. The apparatus for device provisioning includes a communicator and a connection setter. The communicator supports a plurality of network communication methods and communicates through a network connection with a second repeater constituting a network for installation. The connection setter induces the new device to connect to the second repeater based on the initial setting information of the new device, searches the new device among devices connected to the second repeater, and changes the network setting information of the searched new device to the network setting information of the first repeater.

The apparatus for device provisioning may include a device information checker that obtains the initial setting information of the new device, and the initial setting information may include network setting information for network connection of the new device.

The device information checker may obtain the initial setting information through at least one of a QR (Quick Response) code of the new device, barcode recognition, or information provided by the cloud the device information.

The connection setter may change the network setting information of the second repeater to the network setting information of the new device.

### BRIEF DESCRIPTION OF THE DRAWINGS

FIG. 1 is a diagram illustrating an IoT network in operation according to an embodiment.

FIG. 2 is a diagram illustrating an IoT network initial access procedure of a new device according to an embodiment.

FIG. 3 is a diagram illustrating a process in which the smart terminal confirms initial setting information of a new device according to an embodiment.

FIG. 4 is a diagram illustrating an apparatus for device provisioning according to an embodiment.

FIG. 5 is a diagram illustrating an apparatus for device provisioning according to another embodiment.

### DETAILED DESCRIPTION OF THE EMBODIMENTS

Hereinafter, embodiments of the disclosure will be described in detail with reference to the attached drawings so that a person of ordinary skill in the art may easily implement the disclosure. As those skilled in the art would realize, the described embodiments may be modified in various different ways, all without departing from the spirit or scope of the disclosure. Accordingly, the drawings and description are to be regarded as illustrative in nature and not restrictive. Like reference numerals designate like elements throughout the specification.

Throughout the specification and claims, when a part is referred to “include” a certain element, it means that it may further include other elements rather than exclude other elements, unless specifically indicated otherwise.

Now, a method and apparatus for device provisioning according to an embodiment will be described in detail with reference to the drawings.

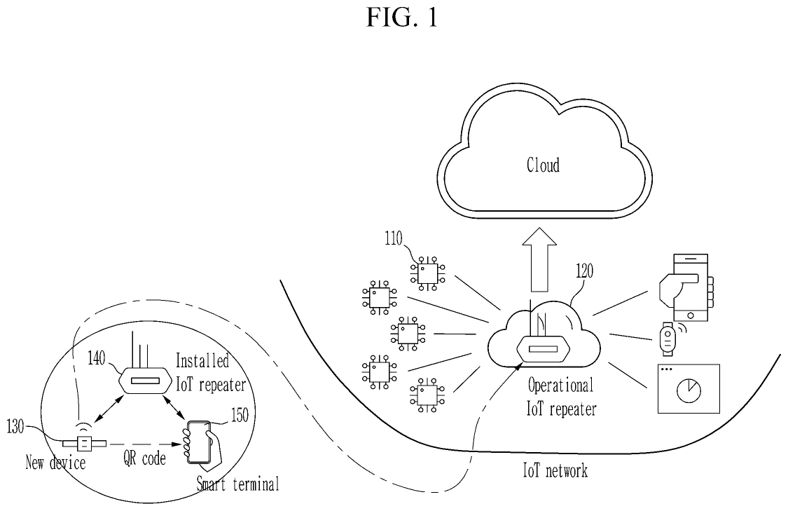

FIG. 1 is a diagram illustrating an IoT network in operation according to an embodiment.

Referring to FIG. 1, an operational IoT repeater 120 configures an IoT network.

An IoT device 110 participates in the IoT network by connecting to the operational IoT repeater 120. The IoT network may include both a general IoT network without security support or a secure IoT network with enhanced security.

The operational IoT repeater 120 collects data of the connected IoT device 110 and transmits the collected data to the cloud through interworking with an external Internet.

The IoT device 130 is a device intended to connect the IoT network in operation for the first time, and will be referred to as a new device 340 in order to distinguish it from the IoT device 110 already participating in the IoT network.

The new device 130 has initial setting information set at the time of manufacture. The initial setting information may include manufacturer initial information, network setting information for network connection, and the like.

In order for the new device 130 to connect the IoT network, it must know the network connection information of the IoT network. If the new device 130 cannot access the IoT network using the network setting information set in the new device 130, as the new device 130 needs to change the network setting information so that it can access the IoT network.

For example, when using a WiFi network, the operating IoT repeater 120 supports the AP function, and the new device 130 requires network connection information such as an SSID (Service Set Identifier), secure-type, and password, which are information necessary for WiFi access to the AP. However, since the new device 130 does not know the network connection information for accessing the IoT network, it cannot access the IoT network.

In addition, when the new device 130 and the smart terminal 150 are directly connected through a communication method such as Bluetooth pairing, the network setting information of the new device 130 can be changed to the network connection information of the IoT network through the smart terminal 150. However, in the case of the new device 130 that cannot support direct connection with the smart terminal 150, a method for setting the network connection information of the IoT network to the new device 130 is required.

According to an embodiment, an installed IoT repeater 140 is used for initial connection to the IoT network of the new device 130.

Since the installed IoT repeater 140 supports various communication methods, it is possible to provide a communication method suitable for the new device 130.

The smart terminal 150 checks the initial setting information of the new device 130, connects to the installed IoT repeater 140, and changes network setting information of the installed IoT repeater 140 using the network setting information of the new device 130, so that the new device 130 can connect to the installed IoT repeater 140. Next, when the new device 130 connects to the installed IoT repeater 140, the smart terminal 150 changes the network setting information of the new device 130 so that the new device 130 can connect the IoT network.

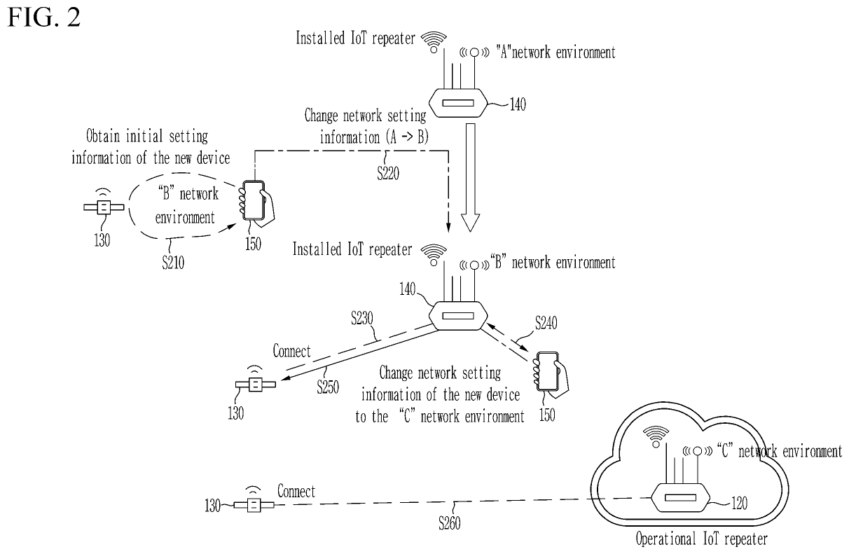

FIG. 2 is a diagram illustrating an IoT network initial access procedure of a new device according to an embodiment.

Referring to FIG. 2, it is assumed that the installed IoT repeater 140 is set in the A network environment and has a communication structure that the smart terminal 150 can connect to. In addition, it is assumed that the operational IoT repeater 120 is set to the C network environment of the IoT network to which the new device 130 wants to connect, and that the smart terminal 150 knows the information of the operational IoT repeater 120 and network connection information of the IoT network.

First, the smart terminal 150 obtains the initial setting information provided by the new device 130 (S210). The smart terminal 150 can check initial setting information provided by the new device 130 through QR (Quick Response) code using a camera, barcode recognition, a serial number provided by the manufacturer of the new device 130, or information provided by the cloud. The new device 130 tries to connect the network according to the network setting information among the initial setting information.

After checking the initial setting information of the new device 130, the smart terminal 150 connects to the installed IoT repeater 140. The smart terminal 150 may connect to the installed IoT repeater 140 by using a communication method suitable for the smart terminal 150 among the network communication methods provided by the installed IoT repeater 140. For example, assuming that the installed IoT repeater 140 supports various network communication methods including WiFi or Bluetooth communication methods, the smart terminal 150 may connect to the installed IoT repeater 140 using the internally set WiFi or Bluetooth communication method.

Next, the smart terminal 150 changes the network setting information of the installed IoT repeater 140 based on the network setting information of the new device 130 so that the new device 130 can connect to the installed IoT repeater 140 (S220). For example, if the network setting information of the installed IoT repeater 140 is set to the A network environment, and the network setting information of the new device 130 is set to the B network environment, the smart terminal 150 changes the network setting information of the installed IoT repeater 140 to the B network environment so that the new device 130 can connect to the installed IoT repeater 140.

After changing the network setting information of the installed IoT repeater 140, the new device 130 can connect to the installed IoT repeater 140 (S230).

Next, the smart terminal 150 connects to the installed IoT repeater 140 in which the network setting information is changed (S240), and searches the new device 130 among the devices connected to the installed IoT repeater 140 based on the initial setting information of the new device 130 obtained through the step (S210).

Next, the smart terminal 150 changes the network setting information of the new device 130 searched based on the already known network connection information of the IoT network to the C network environment (S250).

Then, the new device 130 connects to the operational IoT repeater 120 based on the changed network setting information (S260). In addition, the new device 130 stores network connection information of the IoT network in firmware.

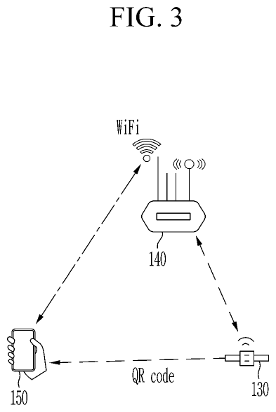

FIG. 3 is a diagram illustrating a process in which the smart terminal confirms initial setting information of a new device according to an embodiment.

Referring to FIG. 3, the smart terminal 150 checks initial setting information provided by the new device 130 through QR (Quick Response) code using a camera, barcode recognition, a serial number provided by the manufacturer of the new device 130, or information provided by the cloud, and can check the manufacturer's initial information and basic network setting information of the new device 130.

In the QR code or barcode recorded when the new device 130 is manufactured, the communication physical address (MAC address in the case of WiFi, MAC address in the case of Zigbee) of the new device 130 and information of the repeater (WiFi AP, gateway, coordinator, etc.) for access of the new device 130 and the like as the basic network setting information for network connection of the manufactured new device 130 are included. However, since it is difficult to connect to the existing IoT network or secure IoT network using the initially recorded information, the initial connection is resolved through the following process.

For the initial connection of the new device 130, the smart terminal 150 may connect to the installed IoT repeater 140 using an accessible communication method provided by the installed IoT repeater 140.

The installation application included in the smart terminal 150 connects to the installed IoT repeater 140 of the network environment A, and then changes the network setting of the installed IoT repeater 140 to the B network environment using the initial setting information obtained from the new device 130 and restarts the installed IoT repeater 140, so that the new device 130 can connect to the installed IoT repeater 140.

The smart terminal 150 connects to the installed IoT repeater 140 in the B network environment, checks the physical address of the new device 130 obtained from a QR code or barcode among device information connected to the installed IoT repeater 140, selects the new device 130, and sets the network connection information of the C network environment for the IoT network in operation to the selected new device 130 by using prior knowledge of the IoT network in operation. In the case of WiFi environment setting, the network connection information includes the WiFi SSID, security type, password, etc. of the operating IoT repeater 120, and in the case of the IEEE 802.15.4 series Zigbee environment setting, the network connection information includes PAN-ID, access channel, code, and the like.

The new device 130 records network connection information of the C network environment in the firmware.

When the new device 130 for which the network setting is completed is restarted, the new device 130 connects to the IoT network of the C network environment in operation according to the network setting information of the C network environment set in the firmware of the new device 130, and then various cloud applications can be interworked through the application service.

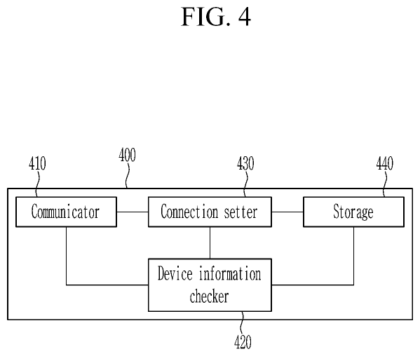

FIG. 4 is a diagram illustrating an apparatus for device provisioning according to an embodiment.

Referring to FIG. 4, the apparatus for device provisioning 400 includes a communicator 410, a device information checker 420, and a connection setter 430. The apparatus for device provisioning 400 may further include a storage.

The communicator 410 supports various network communication methods. The communicator 410 communicates with the operational IoT repeater 120 and the installed IoT repeater 140 through a network connection.

The device information checker 420 obtains initial setting information of the IoT device.

The device information checker 420 may acquire initial setting information of the IoT device through QR code or barcode recognition through a camera.

The connection setter 430 sets a connection with the installed IoT repeater 140, and changes network setting information of the installed IoT repeater 140 based on the initial setting information of the IoT device so that the IoT device can connect to the installed IoT repeater 140. When the IoT device connects to the installed IoT repeater 140, the connection setter 430 searches the IoT device among the devices connected to the installed IoT repeater 140, and changes the network setting information of the IoT device searched to the network setting information of the operational IoT repeater.

The storage 440 stores network setting information of the operating IoT repeater 120 and the installed IoT repeater 140. The storage 440 stores initial setting information of the IoT device.

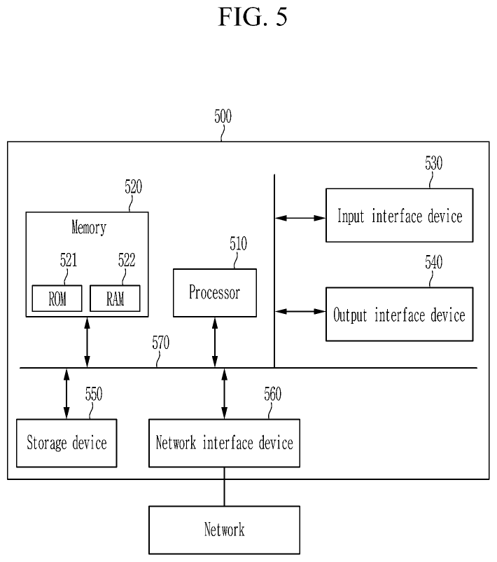

FIG. 5 is a diagram illustrating an apparatus for device provisioning according to another embodiment.

Referring to FIG. 5, the apparatus for device provisioning 500 may represent a computing apparatus in which the above-described method for device provisioning is implemented.

The apparatus for device provisioning 500 may be implemented in the smart terminal 150.

The apparatus for device provisioning 500 may include at least one of a processor 510, a memory 520, an input interface device 530, an output interface device 540, a storage device 550, and a network interface device 560. Each of the components may be connected by a common bus 570 to perform communication with each other. In addition, each of the components may be connected through an individual interface or an individual bus centered on the processor 510 instead of the common bus 570.

The processor 510 may be implemented as various types such as an application processor (AP), a central processing unit (CPU), a graphics processing unit (GPU), etc., and may be any semiconductor device that executes a command stored in the memory 520 or the storage device 550. The processor 510 may execute a program command stored in at least one of the memory 520 and the storage device 550. The processor 510 stores program commands for implementing at least some functions of the device information checker 420 and the connection setter 430 described with reference to FIG. 4 in the memory 520, and may control to perform the operation described with reference to FIGS. 1 to 4.

The memory 520 and the storage device 550 may include various types of volatile or non-volatile storage media. The memory 520 and the storage device 550 may perform the functions of the storage 440 described with reference to FIG. 4. For example, the memory 520 may include a read-only memory (ROM) 521 and a random access memory (RAM) 522. The memory 520 may be located inside or outside the processor 510, and the memory 520 may be connected to the processor 510 through various known means.

The input interface device 530 is configured to provide data to the processor 510.

The output interface device 540 is configured to output data from the processor 510.

The network interface device 560 may transmit or receive signals with other devices, for example, the operational IoT repeater 120 and the installed IoT repeater 140, through a wired network or a wireless network. The network interface device 560 may perform the function of the communicator 410 of FIG. 4.

At least some of the method for device provisioning according to an embodiment may be implemented as a program or software executed in a computing device, and the program or software may be stored in a computer-readable medium.

In addition, at least some of the method for device provisioning according to an embodiment may be implemented as hardware capable of being electrically connected to the computing device.

According to an embodiment, a new IoT node can be provisioned regardless of the communication method used between a new IoT device and the existing IoT network repeater, so that the new IoT device can connect without affecting the existing IoT network or the security-enhanced IoT network.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing, or to control an operation of a data processing apparatus, e.g., by a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (08) and one or more software applications that run on the OS. The processor device also may access, store, manipulate, process, and create data in response to execution of the software. For purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the invention. It will be apparent to one of ordinary skill in the art that various modifications of the embodiments may be made without departing from the spirit and scope of the claims and their equivalents.

What is claimed is:

1. A method for provisioning so that a new device can connect a first repeater in a smart terminal, the method comprising:
changing network setting information of a second repeater constituting a network for installation based on initial setting information of the new device; and
when the new device connects to the second repeater using the initial setting information of the new device, changing the network setting information of the new device to the network setting information of the first repeater.

2. The method of claim 1, wherein the changing of the network setting information of the new device includes:
connecting to the second repeater; and
searching the new device from among devices connected to the second repeater by using the initial setting information of the new device.

3. The method of claim 1, further comprising obtaining the initial setting information of the new device,
wherein the initial setting information includes network setting information for network connection of the new device.

4. The method of claim 3, wherein the obtaining includes obtaining the initial setting information through at least one of a QR (Quick Response) code of the new device, barcode recognition, or information provided by the cloud.

5. The method of claim 3, wherein the changing of the network setting information of the second repeater includes changing the network setting information of the second repeater to the network setting information of the new device.

6. The method of claim 1, further comprising connecting, by the new device, to the first repeater using the changed network setting information.

7. An apparatus for device provisioning so that a new device can connect a first repeater, the apparatus comprising:
a communicator that supports a plurality of network communication methods and communicates through a network connection with a second repeater constituting a network for installation; and
a connection setter that induces the new device to connect to the second repeater based on the initial setting information of the new device, searches the new device among devices connected to the second repeater, and changes the network setting information of the searched new device to the network setting information of the first repeater.

8. The apparatus of claim 7, further comprising a device information checker that obtains the initial setting information of the new device,
wherein the initial setting information includes network setting information for network connection of the new device.

9. The apparatus of claim 8, wherein the device information checker obtains the initial setting information through at least one of a QR (Quick Response) code of the new device, barcode recognition, or information provided by the cloud.

10. The apparatus of claim 8, wherein the connection setter changes the network setting information of the second repeater to the network setting information of the new device.
